(19) United States
(12) Patent Application Publication
(10) Pub. No.: US 2007/0169596 A1
(43) Pub. Date: Jul. 26, 2007

(54) Collet chuck for direct drive rotary stage

(75) Inventor: Brian P. O'Connor, Allison Park, PA (US)

Correspondence Address: THE WEBB LAW FIRM, P.C., 700 KOPPERS BUILDING, 436 SEVENTH AVENUE, PITTSBURGH, PA, 15219, US

(73) Assignee: AEROTECH, INC., Pittsburgh, PA (US)

(21) Appl. No.: 11/336,702

(22) Filed: Jan. 20, 2006

(51) Int. Cl. B23B 31/30

(52) U.S. Cl. 82/165; 279/4.07; 279/43

(57) ABSTRACT

A collet chuck comprises a rotating cylinder block defining a cylindrical axis and an exterior cylindrical surface with first and second annular grooves. A collet and collet sleeve are at least partially surrounded by the rotating cylinder block. A piston slides within an annular interior space in the rotating cylinder block. A stationary port block has an interior cylindrical surface adjacent the exterior cylindrical surface of the rotating cylinder block and connects a first inlet port with a first annular groove and a second inlet port with the second annular groove. Switching pneumatic pressure between the first and second inlet ports moves the piston and collet sleeve between the clamping and unclamping positions and the gap between the rotating cylinder block and the stationary port block provides a frictionless seal.

### BACKGROUND OF THE INVENTION

1. Field of the Invention

The present invention relates to a high precision rotary stage. It is particularly applicable to rotary stages used as a component of a high precision z-theta stage. The z-theta stage has a horizontal translation axis (z-axis) and a rotary axis (theta-axis) parallel with the horizontal translation axis. The stage is especially designed for the manufacture of expandable stents for implantation in a human body or other cylindrical laser-machined components. The stents are manufactured from a tubular feedstock, such as stainless steel, nitinol, or plastic, and are provided with intricate circumferential patterns. Processes for machining the patterns out of the feedstock include laser machining in which a z-theta stage controlled by a CNC controller presents the feedstock to a laser beam for cutting away portions of the tubular feedstock. See U.S. Pat. No. 6,511,504 entitled “Expandable Stents and Method for Making Same” for a description of one stent-manufacturing process.

2. Description of Related Art

U.S. patent application Ser. No. 10/830,979 entitled “High Precision Z-Theta Stage,” assigned to the same assignee as this application, describes a high precision z-theta stage that has a horizontal translation axis (z-axis) and a rotary axis (theta-axis) parallel with the translation axis. The z-theta stage comprises a base plate having upper surfaces lying in a plane and parallel spaced apart linear translation stages each having parallel linear bearings with bearing surfaces mounted at a substantially equal distance from the planar surfaces of the base plate. Each linear translation stage has a brushless linear motor. A carriage is supported between the parallel translation stages by the linear bearings. A rotary stage is housed in the carriage between the parallel translation stages; the rotary stage comprises a brushless rotating motor having a shaft journaled with an axis parallel to the linear bearings. The rotor is preferably hollow to permit a cylindrical workpiece and/or a fluid cooling jacket to be advanced therethrough or positioned therein. The carriage and rotation stage have a vertical and a horizontal center of gravity. Each brushless linear motor is connected to the carriage by applying translation forces in a horizontal plane intersecting the vertical center of gravity of the carriage.

The high precision z-theta stage may have a fluid-actuated, workpiece-holding collet chuck attached to the rotor which is clamped by a spring and unclamped by a pneumatic piston and cylinder. In a known alternate fluid-actuated, workpiece-holding collet chuck, the workpiece is clamped and unclamped by pneumatic pressure.

It is an object, according to this invention, to provide a novel air seal and collet chuck for a direct drive rotary stage that is clamped and unclamped by pneumatic pressure.

### SUMMARY OF THE INVENTION

Briefly, according to this invention, there is provided a pneumatically-operated, workpiece-gripping collet chuck activated through a frictionless air seal mechanism. The main elements comprise a rotating cylinder block, a collet and collet sleeve, a piston, and a stationary port block.

The rotating cylinder block of the present invention defines a cylindrical axis and an exterior cylindrical surface with first and second annular grooves radially inward of the exterior cylindrical surface. In a preferred embodiment, a third annular groove is axially intermediate the first and second grooves. In an alternate preferred embodiment, the third groove is one of third and forth grooves and the third and fourth grooves are located axially outside of the first and second grooves. The rotating cylinder block has an axial bore for accommodating the workpiece. The rotating cylinder block has an annular interior space between the exterior cylindrical surface and the axial bore. One axial end of the annular interior space is connected by a passageway in the cylinder block to the first annular groove and the other axial end is connected by a passageway in the cylinder block to the second annular groove.

The collet and collet sleeve are at least partially surrounded by the rotating cylinder block. They are aligned with the axial bore of the rotating cylinder block for encircling the workpiece.

A piston slides within the annular interior space of the rotating cylinder block. In one axial position, the piston actuates the collet sleeve to clamp the collet on the workpiece and in another axial position, the piston actuates the collet sleeve for releasing the workpiece.

A stationary port block has first and second inlet ports and an exhaust port, the stationary port block having an interior cylindrical surface adjacent the exterior cylindrical surface of the rotating cylinder block. The difference in the diameters of the interior and exterior cylindrical surfaces is established according to known principles so that the air gap will create a noncontact, frictionless flow restriction. In an alternate embodiment, the first and second grooves may be outward from the exterior surface of the stationary port block. A first passageway connects the first inlet port with the first annular groove. A second passageway connects the second inlet port with the second annular groove. In a preferred embodiment, a third passageway connects the third annular groove with an exhaust port.

Switching pneumatic pressure between the first and second inlet ports moves the piston and collet sleeve between the clamping and unclamping positions.

Preferably, the rotating cylinder block is made in two pieces with abutting radial faces fastened together by a bolt passing through one piece and threaded into the other. In this way, when the pieces are separated, the piston can be installed.

Preferably, a nose cap threads on the rotating cylinder block for capturing the collet to the rotating cylinder block enabling rapid changes of collets to accommodate different diameter workpieces.

In one embodiment of this invention, at least a portion of the rotating cylinder block is an extension of a hollow motor shaft. The shaft carrying permanent magnets is journaled by mechanical bearings within the housing 16 containing the stator of a permanent magnet motor.

In one preferred embodiment of this invention, the piston and collet sleeve are formed as one piece. The piston portion comprises a tubular section sized to slide within the annular interior space in the rotating cylinder block and the collet sleeve extends from one axial end of the tubular section having a conical interior for riding over a matching conical exterior of the collet. In this embodiment, at least one O-ring is positioned between the piston and rotating cylinder block. Also, a pin extends from the cylinder block into a bore in the piston to prevent relative rotation between the piston and cylinder block about the cylindrical axis.

### BRIEF DESCRIPTION OF THE DRAWINGS

Further features and other objects and advantages will become clear from the following detailed description made with reference to the drawings in which:

FIG. 1 is a perspective view of a z-theta stage having a single rotary stage in which the collet chuck according to this invention may be used; and

FIG. 2 is a section view through a rotary stage having a collet chuck according to this invention.

### DESCRIPTION OF THE PREFERRED EMBODIMENTS

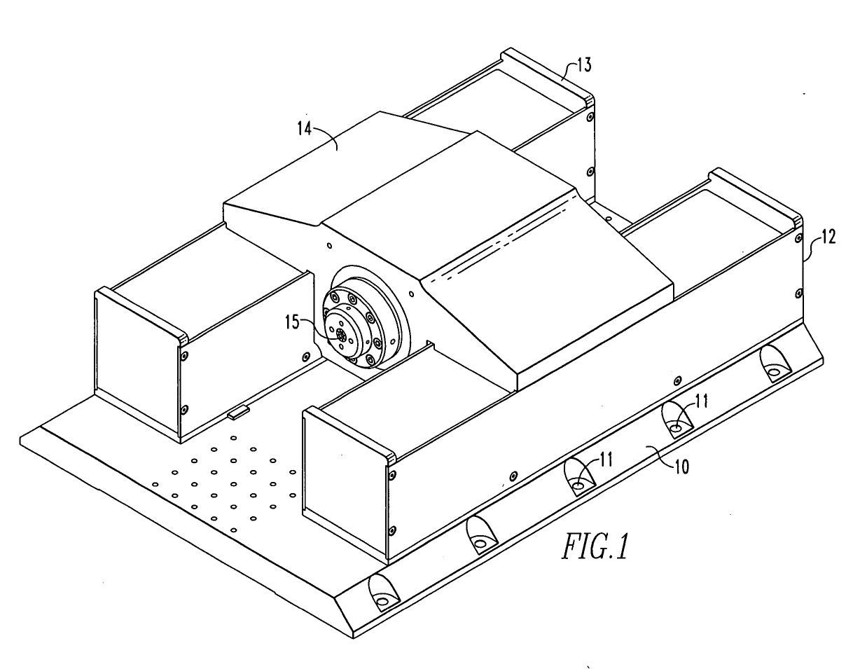

Referring to FIG. 1, there is shown a z-theta stage suitable for manufacture of precision parts, such as stents. The stage includes a base plate 10 which is provided with openings 11 to receive bolts for securing the stage to a foundation which is usually a large piece of granite, casting, or welded structure. The base plate 10 is fabricated from metal, steel, or aluminum, for example. Mounted to the base plate are two parallel linear motor assemblies 12 and 13. Mounted between the linear motor assemblies and carried by them is a carriage 14 which supports a rotary motor 15 having an axis parallel to the translation axes of the linear motors. Preferably, the z-axis is horizontal or substantially horizontal. The linear motors define the z-axis and the rotary motor defmes the theta-axis of the z-theta stage. The linear motors are connected to the carriage to apply translation forces to the carriage directed along the surface of a plane that includes the vertical center of gravity of the carriage or passes as close to the vertical center of gravity as mechanically possible. In this way, the angular displacement between the axis of rotation of the rotary motor and the z-axis plane during a period of rocking following a translation movement is substantially eliminated. Practically speaking, the plane along which the translation forces are applied passes within 1 mm of the vertical center of gravity of the carriage. The axis of rotation of the rotary motor may hang somewhat below the plane upon which translation forces are applied.

The linear motors contained in assemblies 12 and 13 are preferably permanent magnet linear motors, for example, direct drive brushless linear motors consisting of a noncontacting forcer coil and a U-channel rare-earth magnet track. This design eliminates backlash, windup, wear, and maintenance associated with ball screws. Motors of this type are available from, among others, Aerotech, Inc. of Pittsburgh, Pa.

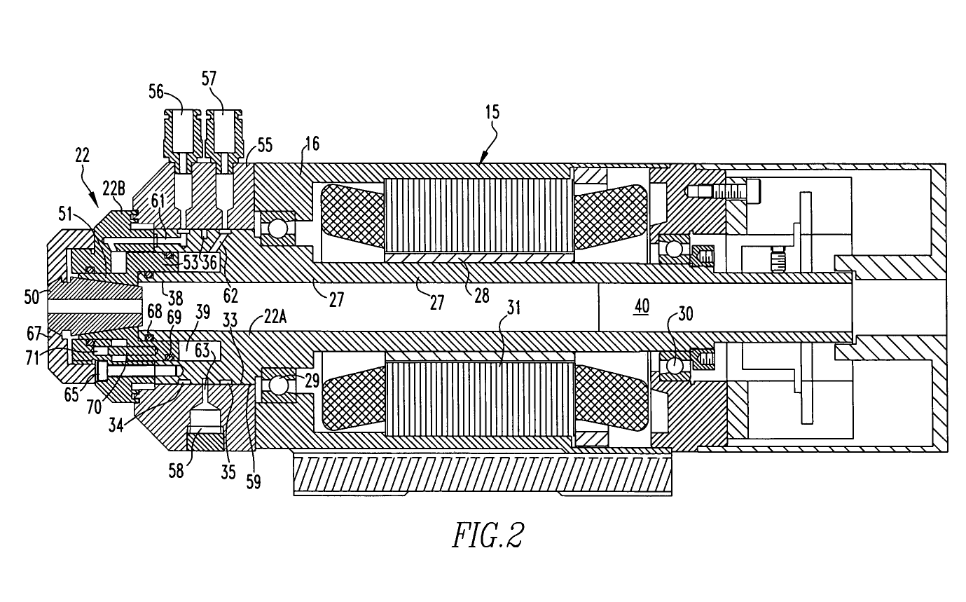

Referring to FIG. 2, extending from the motor shaft is a rotating cylinder block 22 which is an essential element of the air bearing and collet chuck according to this invention.

The rotary motor 15 is preferably a rotary brushless rare-earth magnet servomotor. It forms the basis of a direct drive theta stage. Preferably, the rotating shaft has an axial bore. A motor of this type is available from Aerotech, Inc. of Pittsburgh, Pa.

A portion 22A of the rotating cylinder block 22 is an extension of a hollow motor shaft 27. The shaft carrying permanent magnets 28 is journaled by mechanical bearings 29, 30 within the housing containing the stator 31 of a permanent magnet motor.

The rotating cylinder block 22 of the present invention defines a cylindrical axis and an exterior cylindrical surface 33 with first 34, second 35, and third 36 annular grooves radially inward of the exterior cylindrical surface. The grooves are axially spaced. The third annular groove is axially intermediate the first and second grooves. In an alternate embodiment, the groove can be in the stationary port block. The rotating cylinder block has an axial bore 38 for accommodating the workpiece. The axial bore 38 is aligned coaxial with the hollow bore 40 in the motor shaft. The rotating cylinder block 22 has an annular interior cavity 39 radially spaced between the exterior cylindrical surface 33 and the hollow bore in the motor shaft 40. One axial end of the annular interior space is connected by the hollow bore 61 in the cylinder block to the first annular groove and the other axial end is connected by a passageway 62 in the cylinder block to the second annular groove.

The clearance between the interior cylindrical surface 59 of the stationary port block 55 and the exterior cylindrical surface 33 of the rotating cylinder block 22 between the first and third and between the second and third grooves is approximately five ten thousands of an inch. The axial length of the cylindrical surfaces 33, 59 comprising the air seal exceeds 1 inch.

The collet 50 and collet sleeve 51 are at least partially surrounded by the rotating cylinder block 22. They are aligned with the axial bore of the rotating cylinder block for encircling or gripping the workpiece.

A tubular piston 53 slides within the annular interior space of the rotating cylinder block. In one axial position, the piston actuates the collet sleeve 51 to clamp the collet 50 on the workpiece, and in another axial position, the piston actuates the collet sleeve for releasing the workpiece (not shown).

A stationary port block 55 is fixed relative to the stator of the rotary motor and is typically bolted to the stator housing 16. The port block 55 has first 56 and second 57 inlet ports and an exhaust port 58. The stationary port block has an interior cylindrical surface 59 adjacent the exterior cylindrical surface 33 of the rotating cylinder block 22. The difference in the diameters of the interior and exterior cylindrical surfaces is established according to known principles so that the air gap will create a noncontact, frictionless flow restriction. A first passageway 61 connects the first inlet port 56 with the first annular groove 34 in the rotating cylinder block. A second passageway 62 connects the second inlet port 57 with the second annular groove 35 in the rotating cylinder block. A third passageway 63 connects the third annular groove 36 with an exhaust port 58. It would be possible to eliminate the third angular groove altogether in which case the volume at either end of the interior cavity would bleed through the air seals axially away from the first and second grooves. The air would bleed through bearing 29, for example, and through the gaps in a labyrinth seal between the stationary port block 55 and rotating cylinder block 22.

Switching pneumatic pressure between the first and second inlet ports moves the piston and collet sleeve between the clamping and unclamping positions. When pressure is directed to, say the first inlet port 56, the end of the interior cavity 39 in communication with the second inlet port 57 will be exhausted through the frictionless air seal, the groove 36, and exhaust port 58. Hence, the frictionless seal is not a perfect seal but allows air to bleed through at a controlled rate.

Preferably, the rotating cylinder block is made in two pieces 22A and 22B with abutting radial faces fastened together by bolts 65 passing through one piece and threaded into the other. In this way, when the pieces are separated, the piston 53 can be installed.

Preferably, a nose cap 67 threads on the rotating cylinder block for capturing the collet 50 to the rotating cylinder block enabling rapid changes of collets to accommodate different diameter workpieces.

In one preferred embodiment of this invention, the piston 53 and collet sleeve 51 are formed as one piece. The piston portion comprises a tubular section sized to slide within the annular interior space in the rotating cylinder block and the collet sleeve extends from one axial end of the tubular section having a conical interior for riding over a matching conical exterior of the collet. In this embodiment, at least one O-ring 68, 69 is positioned between the piston and the rotating cylinder block. Also, a pin 70 extends from the cylinder block into a bore 71 in the piston to prevent relative rotation of the piston and the cylinder block about the cylindrical axis.

According to one preferred embodiment, the collet 50 is of the ER-16 Series available in multiple sizes from 0.05 mm to 10 mm. A stationary port block 55 is secured to the armature case 16 of the rotary motor 15.

Having thus defined my invention in the detail and particularity required by the Patent Laws, what is desired protected by Letters Patent is set forth in the following claims.

The invention claimed is:

1. A collet chuck comprising a rotating cylinder block defining a cylindrical axis and an exterior cylindrical surface, a collet and collet sleeve at least partially surrounded by the rotating cylinder block, a piston sliding within an annular interior space in the rotating cylinder block, a stationary port block having an interior cylindrical surface adjacent the exterior cylindrical surface of the rotating cylinder block, first and second annular grooves in one of the rotating cylinder block or the stationary port block abutting said cylindrical surfaces, said stationary port block connecting a first inlet port with the first annular groove and a second inlet port with the second annular groove such that switching pneumatic pressure between the first and second inlet ports will move the piston and collet sleeve between the clamping and unclamping positions and the gap between the rotating and stationary port blocks adjacent the grooves comprising a frictionless seal.

2. The collet chuck according to claim 1 having a third annular groove connected to an exhaust port in the stationary port block.

3. A pneumatically-operated, workpiece-gripping collet chuck comprising:
a rotating cylinder block defining a cylindrical axis and an exterior cylindrical surface with first, second, and third annular grooves radially inward of the exterior cylindrical surface, the third annular groove being axially intermediate the first and second grooves, the rotating cylinder block having an axial bore for accommodating the workpiece, the rotating cylinder block having an annular interior space between the exterior cylindrical surface and the axial bore, one axial end of the interior space is connected by a passageway in the cylinder block to said first annular groove and the other axial end of the interior space is connected by a passageway in the cylinder block to said second annular groove;
a collet and collet sleeve at least partially surrounded by the rotating cylinder block and aligned with the axial bore of the rotating cylinder block for encircling and gripping the workpiece;
a piston sliding within the annular interior space of the rotating cylinder block in one axial position actuating the collet sleeve to clamp the collet on the workpiece and in the other axial position, actuating the collet sleeve for releasing the workpiece; and
a stationary port block having an interior cylindrical surface adjacent the exterior cylindrical surface of the rotating cylinder block, a first passageway connecting a first inlet port with the first annular groove in the rotating cylinder block, a second passageway connecting a second inlet port with the second annular groove in the rotating cylinder block, a third passageway for connecting the third annular groove with an exhaust port,
such that switching pneumatic pressure between the first and second inlet ports will move the piston and collet sleeve between the clamping and unclamping positions and the gap between the rotating cylinder block and the stationary port block between the first or second groove and the third groove serving as a frictionless air seal.

4. The pneumatically-operated, workpiece-gripping chuck of claim 3, wherein the rotating cylinder block is two pieces with abutting radial faces.

5. The pneumatically-operated, workpiece-gripping chuck of claim 3, further comprising a nose cap threaded on the rotating cylinder block for capturing the collet to the rotating cylinder block.

6. The pneumatically-operated, workpiece-gripping chuck of claim 2, wherein at least a portion of the rotating cylinder block is an extension of a hollow motor shaft.

7. The pneumatically-operated, workpiece-gripping chuck of claim 2, wherein the piston and collet sleeve are formed as one piece.

8. The pneumatically-operated, workpiece-gripping chuck of claim 3, wherein the stationary port block and rotating cylinder block have adjacent radial faces with a labyrinth seal formed therein.

9. The pneumatically-operated, workpiece-gripping chuck of claim 3, wherein means are provided to prevent relative rotation of the piston and rotating cylinder block about the cylindrical axis.

10. The pneumatically-operated, workpiece-gripping chuck of claim 3, wherein at least one O-ring is positioned between the piston and rotating cylinder block.

11. A high precision z-theta stage having a horizontal translation axis (z-axis) and a rotary axis (theta-axis) parallel with the translation axis comprising:
parallel spaced apart linear translation stages each having parallel linear bearings with bearing surfaces mounted at a substantially equal distance from the planar surfaces of the base plate, each linear translation stage having a brushless linear motor;
a carriage supported between the parallel translation stages by the linear bearings; and
a rotation stage carried by the carriage between the parallel translation stages, said rotation stage comprising a brushless rotary motor having a shaft journaled with an axis parallel to the linear bearings;
a pneumatically-operated, workpiece-gripping collet chuck comprising:
a rotating cylinder block defining a cylindrical axis and an exterior cylindrical surface with first, second, and third annular grooves radially inward of the exterior cylindrical surface, the third annular groove being axially intermediate the first and second grooves, the rotating cylinder block having an axial bore for accommodating the workpiece, the rotating cylinder block having an annular interior space between the exterior cylindrical surface and the axial bore, one axial end of the interior space is connected by a passageway in the cylinder block to said first annular groove and the other axial end is connected by a passageway in the cylinder block to said second annular groove;
a collet and collet sleeve at least partially surrounded by the rotating cylinder block and aligned with the axial bore of the rotating cylinder block for encircling and gripping the workpiece;
a piston sliding within the annular interior space of the rotating cylinder block in one axial position actuating the collet sleeve to clamp the collet on the workpiece and in the other axial position, actuating the collet sleeve for releasing the workpiece; and
a stationary port block having an interior cylindrical surface adjacent the exterior cylindrical surface of the rotating cylinder block, a first passageway connecting a first inlet port with the first annular groove in the rotating cylinder block, a second passageway connecting a second inlet port with the second annular groove in the rotating cylinder block, a third passageway for connecting the third annular groove with an exhaust port,
such that switching pneumatic pressure between the first and second inlet ports will move the piston and collet sleeve between the clamping and unclamping and the gap between the rotating cylinder block and the stationary port block adjacent the first and second annular grooves comprising a frictionless seal.
